(19) United States
(12) Patent Application Publication
(10) Pub. No.: US 2002/0181637 A1
(43) Pub. Date: Dec. 5, 2002

(54) Radio communication method and apparatus capable of changing transmission rate at every other party

(76) Inventor: Sumie Nakabayashi, Kokubunji (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/156,786

(22) Filed: May 30, 2002

(30) Foreign Application Priority Data
May 31, 2001 (JP) 2001-163675

(51) Int. Cl. H04L 7/00

(52) U.S. Cl. 375/358; 375/372

(57) ABSTRACT

A radio data communication system includes a transmitter which transmits data at a predetermined transmission rate and has a table determining transmission rates in correspondence with reception levels of data, and a receiver which receives data transmitted from the transmitter. The receiver detects data error of the data transmitted from the transmitter and transmits detecting result of the data error to the transmitter. The transmitter obtains a transmission failure rate in response to the detecting result of the data error transmitted from the receiver, and changes the transmission rate with reference to the table based on the transmission failure rate.

### BACKGROUND OF THE INVENTION

The present invention generally relates to a data transmission system and a data transmission method in radio communications. More specifically, the present invention is directed to a radio data communication system and a radio data communication method, capable of changing a transmission rate with respect to each of communication counter parties in accordance with propagation conditions of radio waves (electromagnetic waves).

In communication systems, generally speaking, communications are carried out after communication speeds have been negotiated prior to actual communications executed between transmission terminals and reception terminals. For instance, in group III type facsimile apparatus, while training signals are firstly transmitted in the transmission rate of 9.6 Kbit/s, when better communication conditions are obtained, data transmissions are subsequently carried out at the transmission rate of 9.6 Kbit/s. If communication conditions become worse, then training signals are transmitted at a lower transmission rate than the above-described 9.6 Kbit/s transmission rate, for example, 7.2 Kbit/s. If communication conditions are still bad even under this transmission state, then communication speeds (transmission rates) are furthermore lowered up to 2.4 Kbit/s in a similar manner. As a result, in the above-described communication system, communications can be carried out at optimum communication speeds (optimum transmission rates), depending upon communication line conditions.

On one hand, very recently, packet communications may constitute major communications in data communication fields. However, in wired LANs (Local Area Networks) such as Ethernet (trademark), since data transmission qualities can be maintained at a certain level, communication speeds are constant values which are set to the individual data communication systems. On the other hand, similarly, in wireless LANs, although data transmission qualities are adversely influenced by propagation environments, distances among wireless terminals, and the like, data communications are carried out at constant communication speeds which have been previously set.

In the above-described conventional techniques, while one transmission rate is selected from a plurality of transmission rates (plural communication speeds) which are supported by both a transmission station and a reception station, a communication is subsequently carried out at the selected transmission rate. However, in a wireless access service used under outdoor environment, a signal reception level measured at a wireless terminal (radio terminal) which is located near a base station and located at a line-of-sight position from this base station is largely different from a signal reception level measured at another wireless terminal (radio terminal) which is located far from the above-described base station. In other words, when such a transmission rate at which a data communication can be carried out without any problem in a wireless terminal located close to a base station is applied to another wireless terminal located far from this base station, there are some possibilities that data errors happen to occur, and thus, ACK (acknowledge) signals from a wireless terminal functioning as a transmission destination are not received at another wireless terminal.

As a consequence, for instance, in a so-called “auto rate fallback system”, in the case that an ACK signal is not received at a transmission source, next data is retransmitted by decreasing the presently-used transmission rate by 1 rank. Even at this lower transmission rate, if the ACK signal is not received at the transmission source, the next data is resent by further decreasing this lowered transmission rate by 1 rank.

JP-A-2000-49663 discloses a radio communication device and transmission rate control method in which the communication terminal device measures reception quality and reports the measurement result to a base station device, which switches the transmission rate by a transmission rate switching control circuit according to the report result of the reception quality, and, consequently, the transmission rate begins to be switched once the reception quality of the communication terminal device becomes worse.

### SUMMARY OF THE INVENTION

In the above-described auto rate fallback system, data is actually transmitted and a confirmation is made as to whether or not an ACK signal is received and thereafter propagation conditions of radio waves can be essentially grasped. As a consequence, in the case that the propagation conditions of the radio waves are deteriorated, useless data would be transmitted. Also, in such a case that the propagation conditions of the radio waves are brought into the worst propagation conditions, the data should be retransmitted, or resent many times until proper transmission rates could be established. Thereafter, a total retransmission number of times of these data is increased, so that the following drawbacks occur. That is, the throughput of this auto rate fallback system is lowered, or since a total retransmission number of times of the data exceeds a predetermined value, no data communication can be carried out.

In the radio communication device and transmission rate control method disclosed in JP-A-2000-49663, the transmission rate is not determined or switched in the communication terminal device in response to the measurement result of the reception quality but the measurement result is reported to the base station device which in turn switches the transmission rate according to the report result of the reception quality.

An object of the present invention is to provide a radio data communication system and a radio data communication method, capable of solving the above-described drawbacks of the conventional techniques.

Another object of the present invention is to provide a radio data communication system and a radio data communication method, capable of realizing an optimum communication in accordance with propagation conditions of radio waves so as to improve a throughput of an entire radio communication system.

To achieve the above-described object, a radio data communication method, according to an aspect of the present invention, is arranged in a manner that in a radio data communication system comprising a transmitter which transmits data at a predetermined transmission rate and having a table determining transmission rates in correspondence with reception levels of data, and a receiver which receives data transmitted from the transmitter, a data transmission method in the radio data communication system comprising the steps of:

a) at the receiver, detecting data error of the data transmitted from the transmitter;

b) at the receiver, transmitting detecting result of the data error to the transmitter; and

c) at the transmitter, obtaining a transmission failure rate in response to the detecting result of the data error transmitted from the receiver, and changing the transmission rate with reference to the table based on the transmission failure rate.

According to such an arrangement or method, an optimum communication can be realized in accordance with propagation conditions of radio waves thereby to improve a throughput of an entire radio communication system.

Also, as an example, a measuring unit of the radio apparatus according to the present invention performs a measurement of a reception level in such a manner that while the management frame signal of the MAC (Media Access Control) layer defined in the IEEE 802.11 standard is employed as a level measuring subject, a reception level of a management frame signal transmitted from a communication counter party is measured.

Also, as one example, the radio data communication method further comprising a step of:

d) at each of the transmitter and the receiver, measuring a reception level of a signal which is transmitted from a communication counter party and is received, and determining a transmission rate of data which is transmitted to the communication counter party based upon the measured reception level; wherein:

the data is transmitted to the communication counter party at the determined transmission rate.

Also, as one example, in the radio data communication method, the step d) measures a reception level of a management signal, or a control signal, which are received from the communication counter party, prior to the transmission of the data.

Also, as one example, in the radio data communication method, the step d) determines a plurality of transmission rates at which data can be transmitted to a communication counter party based upon the management signal received to the communication counter party, and determines one transmission rate corresponding to the measured reception level among the determined plural transmission rates at which the data can be transmitted to the communication counter party, as a transmission rate of the data transmitted to the communication counter party.

Also, as one example, in the radio data communication method, the step c) is comprised of:

a step c1) for counting both a total transmission number of times of data and either a total transmission success number of times of data or a total transmission failure number of times of data in the transmitter in response to the detecting result of the data error;

a step c2) in which when a ratio of a total transmission failure number of times with respect to a total transmission number of times in the transmitter exceeds a first predetermined value, a transmission rate of data transmitted to the receiver is changed into a lower transmission rate than the transmission rate;

a step c3) in which when a ratio of a total transmission failure number of times with respect to a total transmission number of times in the transmitter is smaller than a second predetermined value, a transmission rate of data transmitted to the receiver is changed into a higher transmission rate than the transmission rate; and

a step c4) in which, subsequently, the data is transmitted at the changed transmission rate to the receiver.

Also, as one example, the radio data communication method further comprising the steps of:

registering thereinto the transmission rates determined by the step d) with respect to the receiver; and

when a transmission rate of data transmitted to the receiver is changed by the step c), updating the transmission rate of the data corresponding to the receiver, which has been previously registered, by the changed transmission rate, wherein, subsequently, the data is transmitted to the receiver at the updated transmission rate.

Also, as one example, in the radio data communication method, the register step registers thereinto the transmission rate determined by the step d) in correspondence with an MAC (Media Access Control) address of the receiver.

Also, as one example, in the radio data communication method, the step c) counts a total transmission number of times of data at a layer lower than, or equal to an MAC layer.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic block diagram for indicating an arrangement of a radio apparatus employed in a radio terminal, according to an embodiment of the present invention.

FIG. 2 is a schematic block diagram for showing an arrangement of a radio apparatus employed in a base station, according to an embodiment of the present invention.

FIG. 3 is an explanatory diagram for explaining an embodiment of a radio communication system of the present invention.

FIG. 4A to FIG. 4F are diagrams for representing structures of signals used in the radio communication system according to one embodiment of the present invention.

FIG. 5 is an explanatory diagram for explaining an embodiment of a request response sequence operation defined until a communication is commenced between a base station and a radio terminal, to which a radio data communication method and system of the present invention is applied.

FIG. 6 is a diagram for illustratively indicating a signal structure of transmission data used in one embodiment of the present invention.

FIG. 7A to FIG. 7C are diagrams for illustratively showing register tables used in one embodiment of the present invention.

FIG. 8 is a flow chart for describing a method of setting transmission rates every communication counter party, executed in one embodiment of the present invention.

FIG. 9 is a flow chart for describing a method of resetting transmission rates in response to radio wave propagation conditions, executed in one embodiment of the present invention.

### DESCRIPTION OF THE EMBODIMENTS

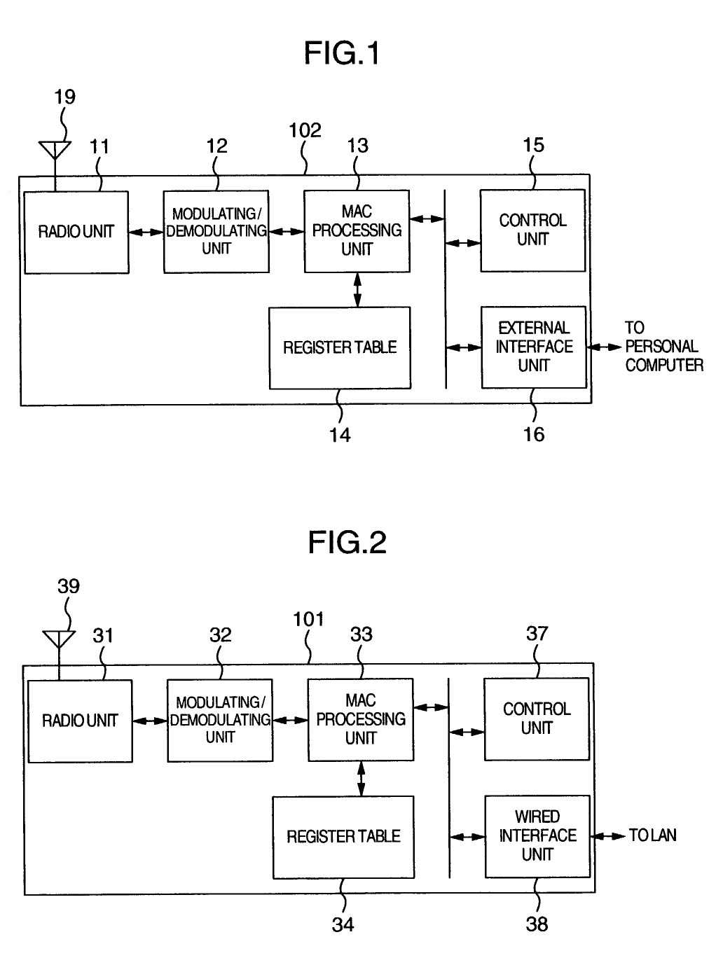

Referring now to FIG. 1 and FIG. 2, a description will be made of such a case that a radio data communication system and method according to an embodiment of the present invention is applied to a wireless LAN (Local Area Network) standardized by IEEE 802.11. IEEE 802.11 corresponds to such a standard (specification) as to a physical layer and MAC (Media Access Control) layer of a wireless LAN. This MAC layer corresponds to the lower layer within the data link layer of the OSI (Open System Interconnection) layers.

FIG. 1 and FIG. 2 are schematic block diagrams for indicating a structural example of a ratio apparatus of a radio terminal, and a structural example of a radio apparatus of a base station, according to an embodiment of the present invention, respectively. The radio apparatus 102 of the radio terminal is arranged by an antenna 19, a radio unit 11, a modulating/demodulating unit 12, an MAC processing unit 13, a register table 14, a control unit 15, and also, an external interface unit 16 used to be connected to a personal computer and the like. Similar to the above-described radio apparatus 102, the radio apparatus 101 of the base station is arranged by an antenna 39, a radio unit 31, a modulating/demodulating unit 32, an MAC processing unit 33, a register table 34, a control unit 37, and also, a wired interface unit 38 used to be connected to a network and the like.

In FIG. 1 and FIG. 2, the MAC processing units 13 and 33 execute access control operations of radio sections, whereas the control units 15 and 37 perform protocol process operations of layers not lower than the MAC layer, and also execute control operations of entire units of either the radio apparatus 102 and the radio apparatus 101.

In the case that the radio apparatus 102 of the radio terminal performs transmission operation, the MAC processing unit 13 produces a transmission frame (signal) to output this transmission frame (signal) to the modulating/demodulating unit 12. The modulating/demodulating unit 12 modulates the inputted transmission frame (signal), and then, outputs the modulated transmission frame (signal) to the radio unit 11. The radio unit 11 converts the entered modulation signal into a radio signal and then, outputs the converted radio signal via the antenna 19.

Similarly, in the case that the radio apparatus 101 of the base station performs transmission operation, the MAC processing unit 33 produces a transmission frame (signal) to output this transmission frame (signal) to the modulating/demodulating unit 32. The modulating/demodulating unit 32 modulates the inputted transmission frame (signal), and then, outputs the modulated transmission frame (signal) to the radio unit 31. The radio unit 31 converts the entered modulation signal into a radio signal and then, outputs the converted radio signal via the antenna 39.

On the other hand, in the case that the radio apparatus 102 of the radio terminal performs reception operation, the radio unit 11 receives a radio signal through the antenna 19, and executes a synchronization process operation, a removing process operation of an unnecessary frequency component, and a frequency converting process operation, and then, outputs the processed signal to the modulating/demodulating unit 12. The modulating/demodulating unit 12 demodulates the reception signal entered from the radio unit 11 so as to recover the reception frame(signal), and then, outputs the reception frame (signal) to the MAC processing unit 13. The MAC processing unit 13 performs a process operation of the reception frame (signal).

Similarly, in the case that the radio apparatus 101 of the base station performs reception operation, the radio unit 31 receives a radio signal through the antenna 39, and executes a synchronization process operation, a removing process operation of an unnecessary frequency component, and a frequency converting process operation, and then, outputs the processed signal to the modulating/demodulating unit 32. The modulating/demodulating unit 32 demodulates the reception signal entered from the radio unit 31 so as to recover the reception frame (signal), and then, outputs the reception frame (signal) to the MAC processing unit 33. The MAC processing unit 33 performs a process operation of the reception frame (signal).

As signals communicated between the radio terminal and the base station, for instance, there are provided: a control signal communicated between the respective MAC processing units 13 and 33, another control signal communicated between the control unit 15 and the control unit 37, and transmission/reception data communicated between the external interface unit 16 and the wired interface unit 38. Between the external interface unit 16 and the wired interface unit 38, for example, such communication data between a personal computer provided on the side of the radio terminal and another personal computer connected to, for instance, a network (e.g., local area network: LAN) provided on the side of the base station are transmitted/received.

As transmission/reception operations performed between the external interface unit 16 and the wired interface unit 38, either the MAC processing unit 13 or the MAC processing unit 33 enters thereinto data which is supplied from either the external interface unit 16 or the wired interface unit 38 so as to produce an MAC frame, and then, transmits this produced MAC frame. Also, either the MAC processing unit 13 or the MAC processing unit 33 recovers the original data from the MAC frame, and then, supplies the recovered data to either the external interface unit 16 or the wired interface unit 38. The control signal is communicated between the control unit 15 and the control unit 37 in a similar manner.

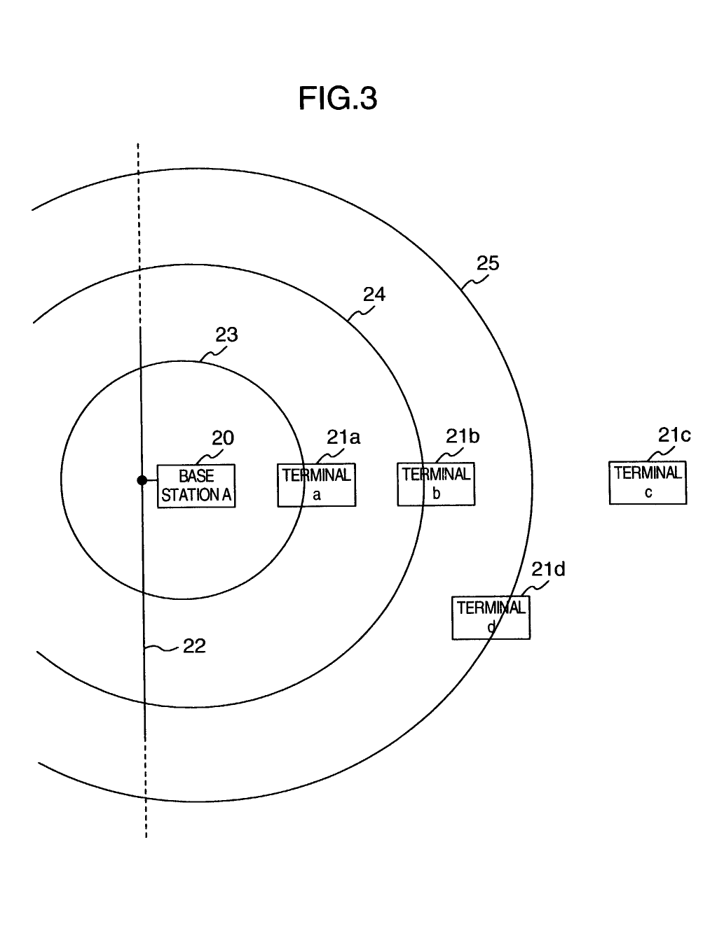

Referring now to FIG. 3, a radio communication method according to an embodiment of the present invention will be described. FIG. 3 is an explanatory diagram for explaining one embodiment of a radio communication system to which the radio communication method of the present invention is applied.

The radio communication system of FIG. 3 is constructed of a base station A20, a radio terminal a21a, another radio terminal b21b, another radio terminal c21c, and also, another radio terminal d21d.

The base station A20 is connected to another base station (not shown) by way of a wired network 22.

Also, concentric circles 23, 24, and 25 shown in FIG. 3 indicate such places, or locations whose distances from the base station A20 are equal to each other.

In other words, the radio terminal a21a is located at the first nearest position (within concentric circle 23) with respect to the base station A20; the radio terminal b21b is located at the second nearest position (within concentric circuit 24); the radio terminal d21d is located at the third nearest position (within concentric circle 25); and also, the radio terminal c21c is located at the farthest position (outside concentric circle 25) with respect to the base station A20.

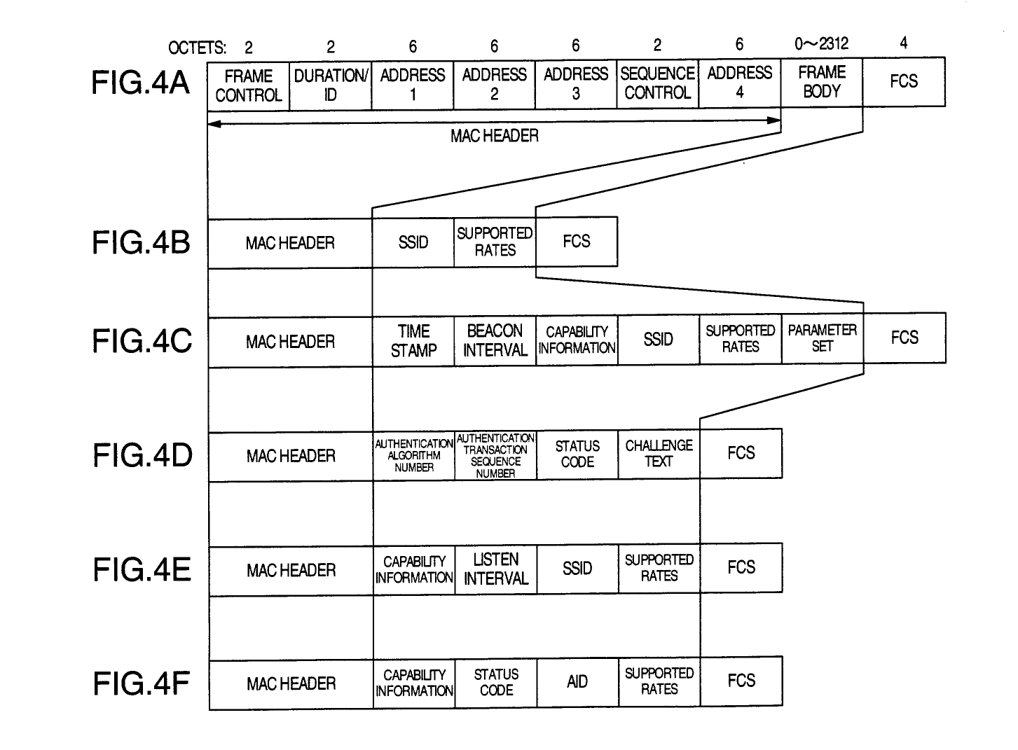

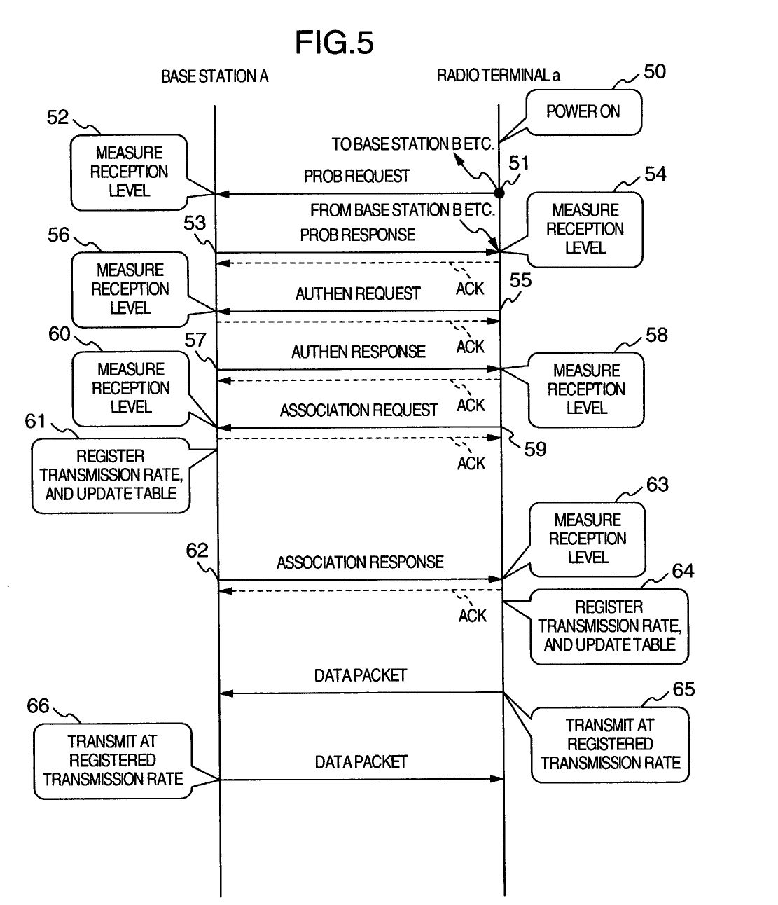

Next, a description will now be made of an embodiment of a management frame (management signal) which is used before a communication is commenced between a base station and a radio terminal with reference to FIG. 4A to FIG. 4F. FIG. 4A through FIG. 4F are diagrams for illustratively showing structures of signals of one embodiment of the present invention, while these signals are used to communicate between, for example, the base station A20 and the radio terminal a21a.

FIG. 4A represents a general-purpose MAC frame format. An MAC header is constituted by a Frame Control field indicative of a frame duration indicative of a frame sort and the like and, a duration ID indicative of a frame sort and the like and Addresses 1 to 4 representative of destination MAC addresses and transmission source MAC addresses, and a Sequence Control field indicative of sequence control information. A Frame Body corresponds to a main body portion of data which is transmitted/received in the MAC frame. As indicated in this drawing, management frame fields or transmission/reception data of an End-To-End are contained in this Frame Body. Also, an FCS (frame check sequence) corresponds to bits used to check data errors of the MAC frame.

FIG. 4B to FIG. 4F represent one example of frame formats of management frames which are applied to the present invention. FIG. 4B is a signal structure of a Prob Request signal which is constituted by an SSID(Service Set Identifier), Supported Rates, an FCS, subsequent to the MAC header. FIG. 4C is a signal structure of a Prob Response signal which is constituted by a Time Stamp, a Beacon Interval, Capability Information, an SSID, Supported Rates, a Parameter Set, and an FCS, subsequent to the MAC header. Also, FIG. 4D is a signal structure of an Authentication frame signal used for both an Authen. request signal and an Authen. response signal. This Authentication frame signal is constituted by an Authentication Algorithm Number, an Authentication Transaction Sequence Number, a Status Code, a Challenge Text, and an FCS, subsequent to the MAC header. A decision as to whether a signal corresponds to the Authen. request signal, or the Authen. response signal may be made based upon an Authentication Transaction Sequence Number. Further, FIG. 4E is a signal structure of an Association Request signal. This Association Request signal is constituted by Capability Information, a Listen Interval, an SSID, Supported Rates, and an FCS, subsequent to the MAC header. Furthermore, FIG. 4F is a signal structure of an Association Response signal. This Association Response signal is arranged by Capability Information, a Status Code, an AID, Supported Rates, and an FCS, subsequent to the MAC header.

In the IEEE 802.11 standard, in the case that a communication is performed between a base station and a radio terminal, the management frame (signal) of the MAC layer is transmitted/received prior to a data transmission.

In the beginning, in such a case that the radio terminal a21a starts a communication, the MAC processing unit 13 produces a Prob Request signal to transmit this Prob Request signal in order to retrieve a peripheral base station to which this radio terminal a21a can be communicated. The Prob Request signal contains a service set ID (SSID) communicable with the radio terminal a21a, and information of a Supported Rate which indicates a transmission rate (communication speed) under support.

When the Prob Request signal transmitted from the radio terminal a21a is received, the MAC processing units 33 of all of the base stations produce Prob Response signals so as to respond to this radio terminal a21a, while these base stations including the base station A20 receive the Prob Request signal transmitted from the radio terminal a21a. As indicated in FIG. 4C, the Prob Response signal contains, for example, such information as Beacon Interval in addition to the information of SSID and Supported Rate.

Subsequently, as to signals which are transmitted/received between the base stations and the radio terminal, both the producing process operation and the determining process operation are carried out in the respective MAC processing units 13 and 33.

When the user of this radio terminal a21a selects such a base station (for example, base station A20), to which this radio terminal a21a wants to communicate, from all of the base stations (including base station A20) which transmit the Prob Response signals in response to the Prob Request signal sent from the radio terminal a21a, this radio terminal a21a stores thereinto the selected base station, and belongs to this base station after the authentication processing operation has been accomplished.

Subsequently, when a data communication is carried out, the data is transmitted at a transmission rate which is supported by a communication counter party.

For instance, as indicated in FIG. 3, while a plurality of radio terminals a21a to d21d are connected to the base station A20, there are various different distances from the base station A20 up to the plural radio terminals a21a to d21d. In accordance with the IEEE 802.11a standard, the transmission rate may be set to 8 stages of 6 Mbit/s, 9 Mbit/s, 12 Mbit/s, 18 Mbit/s, 24 Mbit/s, 36 Mbit/s, 48 Mbit/s, and 54 Mbit/s. These 8 stages of transmission rates are contained as the information as to the Supported Rate in the Frame Body of the management frame transmitted from either the base station or the radio terminal.

On the other hand, for example, even in such a case that data can be communicated without any problem at the transmission rate of 54 Mbit/s between the base station A20 and the radio terminal a21a, a reception level of a radio signal transmitted from the base station A20 at the radio terminal c20c is low between the base station A20 and the radio terminal c20c which is located far from this base station A20. As a result, even when the data communication is carried out in the maximum supported transmission rate (namely, 54 Mbit/s in this case) among the supported transmission rates between the base station A20 and the radio terminal c20c, data errors may occur many times. As a result, a total number of times of data resending operations is increased, and therefore, a throughput is lowered, or the total number of times of the data resending operations exceeds a predetermined value. As a consequence, such a condition that the data communication cannot be completely carried out may happen to occur.

In other words, if the base station A20 communicates with both the radio terminal a21a and the radio terminal c21c at the same transmission rate, then the data transmission can be hardly carried out in a higher efficiency over the entire system.

As a consequence, in accordance with the present invention, since a transmission rate may be separately set with respect to each of the communication counter parties, a data communication may be carried out at a high transmission rate by a radio terminal located at a place with a better line condition, whereas a data communication may be carried out at a low transmission rate by a radio terminal located at a place with a worse line condition, so that a throughput of the entire system can be improved.

Next, a description will now be made of a method for setting transmission rates every communication counter party (namely, radio terminal). As previously explained, a base station and a radio terminal transmit/receive various sorts of management frames between them. FIG. 4A to FIG. 4F show the signal structure of the MAC layer signal defined in IEEE 802.11 standard. In this MAC layer signal, an MAC address field indicative of a transmission source is contained in an MAC header. Each of MAC addresses (namely, Address 1, Address 2, Address 3, and Address 4) is constructed of 6 octets, while 3 octets are used to set a vender identifier, and the remaining 3 octets are used to set the number specific to the own apparatus. Based upon this MAC address, an appliance may be identified.

When a management frame (signal) is received, a reception station (either base station or radio terminal) measures a reception level of a radio signal in the modulating/demodulating unit 12 (otherwise 32), and then, notifies the measured reception level to the MAC processing unit 13 (otherwise 33). The MAC processing unit 13 (otherwise 33) reads out a transmission source MAC address from the received management frame, and then, registers one transmission rate corresponding to the read transmission source MAC address into the register table 14 (otherwise 34). At this time, for instance, if the MAC address of the radio apparatus of either the base station or the radio terminal, which transmits this radio signal, is stored in Address 2 of the MAC header of the reception signal, and also, the transmission rate is registered in the register table 14 (otherwise 34) in correspondence with the transmission source MAC address, then the communications can be carried out at the different transmission rates from each other with respect to each of the radio terminals and also each of the base stations.

Although will be explained in detail, a decision of such transmission rates is made as follows: First, a plurality of transmission rates at which communications can be established with a commination counter party may be determined, namely, a plurality of transmission rates which are supported by this communication counter party may be determined based upon a Supported Rate field (see FIG. 4C) contained in either the Prob Request signal received from the communication counter party (transmission source) or the Prob Response signal. Thereafter, one optimum transmission rate is selected based on the reception level, and a determination is made as to whether or not the selected transmission rate is supported by the communication counter party. In the case that this selected transmission rate is supported by the communication counter party, this supported optimum transmission rate is registered in the register table 14 (otherwise 34).

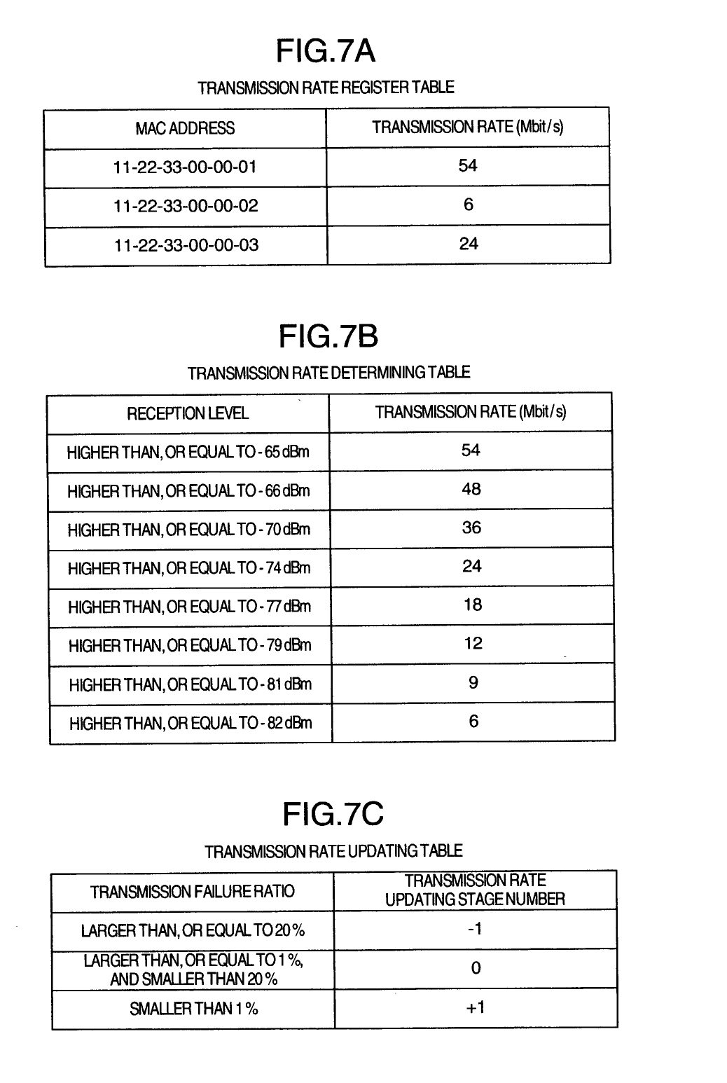

In the case that the transmission rate which has been selected based upon the reception level is not supported by the communication counter party, such a transmission rate which corresponds to the closemost transmission rate with respect to this selected transmission rate is selected from the plural supported transmission rates, and then, this selected closemost transmission rate is written into the register table 14 (or 34). Namely, this optimum closemost transmission rate corresponds to such a closemost transmission rate selected from lower transmission rates than the selected transmission rate. A method for selecting an optimum transmission rate from a reception level is performed as follows: In other words, transmission rates corresponding to a reception level-to-packet error rate characteristic (namely, error rate per reception level) are previously stored into a transmission rate determining table (namely, see table of FIG. 7B, will be explained later) in either a base station or a radio terminal. For example, there is such a method capable of setting maximum transmission speeds at which a packet error rate in a measured reception level becomes lower than, or equal to 10%. The transmission rate determining table of FIG. 7B is established in accordance with the above-described reference.

Subsequently, when data is transmitted, either a base station or a radio terminal performs a data transmission at such a transmission rate which has been registered in correspondence with a destination MAC address with reference to this transmission rate determining table.

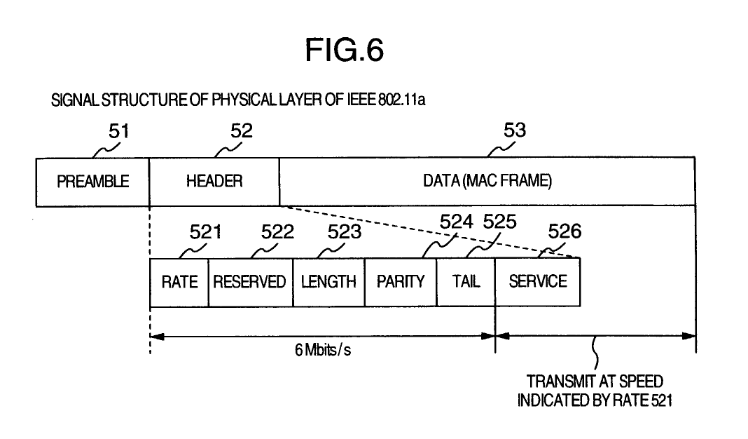

FIG. 6 is a diagram for schematically indicating a signal structure of transmission data of a physical layer according to an embodiment of the present invention. As indicated in FIG. 6, the signal structure of the transmission data of the physical layer is arranged by a preamble portion 51, a header portion 52, and a data portion 53. This header portion 52 is constituted by a Rate field 521, a Reserved field 522, a LENGTH field 523, a Parity field 524, a Tail field 525, and also, a SERVICE field 526. Further, the MAC frame of FIG. 4A is described in the data portion 53 of the signal.

One symbol of the header portion 52 of the signal is transmitted at the fixed transmission rate of 6 Mbit/s. The data portion 53 subsequent to the header portion 52 is transmitted at such a transmission rate indicated by the Rate field 521 of the header portion 52 transmitted at this transmission rate of 6 Mbit/s.

As a result, since the header portion 521 of the transmission data is read out in a reception station, this reception station can receive the data at the different communication speeds in the unit of a packet.

FIG. 5 is an explanatory diagram for explaining an embodiment of a request response sequence executed until a communication is commenced between a base station (e.g., base station “A” in this case) and a radio terminal (e.g., radio terminal “a” in this case), to which the radio communication method of the present invention is applied.

FIG. 5 represents one example of a sequential operation defined from a measurement of a reception level up to a decision of a transmission rate.

In FIG. 5, first of all, when the power supply of the radio terminal a21a is turned ON (step 50), this radio terminal a21a broadcasts a Prob Request signal to both the base station A, another base station B, and the like in order to start a communication with the base station A20 (step 51).

The base station A20 receives the Prob Request signal transmitted from the radio terminal a21a, a reception level of the received Prob Request signal is measured in the modulating/demodulating unit 32 (step 52), and then, the measured reception level is notified to the MAC processing unit 33. The MAC processing unit 33 reads out a transmission source MAC address from the received Prob Request signal, and then, temporarily stores both the transmission source MAC address and the information related to the measured reception level into a memory contained in the MAC processing unit 33(otherwise, control unit 37). Other base stations execute process operations similar to the above-described process operation. The respective base stations which receive the Prob Request signals transmit Prob Response signals (step 53).

In the radio terminal a21a, the modulating/demodulating unit 12 measures reception levels of the respective Prob Response signals received from a plurality of base stations (step 54), and then, notifies the measured reception levels to the MAC processing unit 13. The MAC processing unit 13 selects a desirable base station (e.g., base station “A” in this case) which has been set by the user, reads out a transmission source MAC address of this base station “A”, and then, temporarily stores both this transmission source MAC address and the information as to the measured reception levels into the memory contained in the MAC processing unit 13 (or control unit 15). Thereafter, the radio terminal a21a transmits an Authen. request signal to the base station “A” (step 55).

In the base station A20, the Authen. request signal is received and a reception level thereof is measured by the modulating/demodulating unit 12 (step 56), and then, the measured reception level is notified to the MAC processing unit 33. The MAC processing unit 33 reads out a transmission source MAC address from the received Authen. request signal, and temporarily stores both the transmission source MAC address and the information related to the measured reception level into the memory contained in the MAC processing unit 33 (or control unit 37). Thereafter, the base station “A” sends an Authen. response signal to the radio terminal a21a (step 57).

In the radio terminal a21a, the modulating/demodulating unit 12 measures a reception level of the Authen. response signal (step 58), and then, the measured reception level is notified to the MAC processing unit 13. The MAC processing unit 13 reads out a transmission source MAC address from the received Authen. response signal, and temporarily stores both the transmission source MAC address and the information related to the measured reception level into the memory contained in the MAC processing unit 13 (or control unit 15). Thereafter, the radio terminal a21a sends an Association Req. signal to the base station “A” (step 59).

In the base station A20, a reception level of the Association Req. signal is measured by the modulating/demodulating unit 32 (step 60), and then, the measured reception level is notified to the MAC processing unit 33. The MAC processing unit 33 reads out a transmission source MAC address from the received Association Req. signal and temporarily stores both the transmission source MAC address and the information related to the measured reception level into the memory contained in the MAC processing unit 33 (or control unit 37). Furthermore, the MAC processing unit 33 or the control unit 37 determines a reception level sent from the radio terminal a21a in combination with such a reception level which has been measured at the same MAC address (namely, MAC address of radio terminal a21a in this case) in the past and has been temporarily stored. As the reception level determining method, for example, there is such a determining method. That is, an average value of the respective measurement values as to the reception signal levels of the above-described various sorts of management frames is calculated. In other words, this reception level determining method is to calculate an average value, or an intermediate value of a plurality of various reception levels which have been temporarily stored. In this case, a correct value may be obtained. Alternatively, in this case, while all of the Prob Request signal, the Authen. request signal, and Association Req. signal are employed, any two signals of these signals may be used. Also, any one of measurement results as to the Prob Request signal, the Authen. request signal, and the Association Req. signal may be employed.

The MAC processing unit 33 determines a transmission rate with reference to the transmission rate determining table with respect to the determined reception level, and then, registers (otherwise updates) the determined transmission rate into the register table 34 (step 61).

In the radio terminal a21a, a reception level of the Association Res. signal is measured by the modulating/demodulating unit 12 (step 63), and then, the measured reception level is notified to the MAC processing unit 13. The MAC processing unit 13 reads out a transmission source MAC address from the received Association Res. signal, and temporarily stores both the transmission source MAC address and the information related to the measured reception level into the memory contained in the MAC processing unit 13 (or control unit 15). Furthermore, the MAC processing unit 13 or the control unit 15 determines a reception level sent from the base station “A” in combination with such a reception level which has been measured at the same MAC address (namely, MAC address of base station “A” in this case) in the past and has been temporarily stored. As the reception level determining method, similar to the above-described determining method, for example, there is such a determining method. That is, an average value of the respective measurement values as to the reception signal levels of the above-described various sorts of management frames is calculated. In other words, this reception level determining method is to calculate an average value, or an intermediate value of a plurality of various reception levels which have been temporarily stored. In this case, a correct value may be obtained. Alternatively, in this case, while all of the Prob Response signal, the Authen. response signal, and Association Res. signal are employed, any two signals of these signals may be used. Also, any one of measurement results as to the Prob Response signal, the Authen. response signal, and the Association Res. signal may be employed. The MAC processing unit 13 determines a transmission rate with respect to the determined reception level, and then, registers (otherwise updates) the determined transmission rate into the register table 14 (step 64).

It should be noted that the base station “A” transmits an ACK signal corresponding to a control signal in response to the Authen request signal and the Association Req. signal, whereas the radio terminal a21a transmits an ACK signal in response to the Prob. Response signal, the Authen. response signal, and the Association Res. signal. As a consequence, in the base station “A” and the radio terminal a21a, while the reception level of the ACK signal is measured, a reception level may be determined based upon either one or a plurality of the measured ACK signals.

Alternatively, the radio terminal a21a may measure a reception level based on a beacon signal (management frame) transmitted from the base station “A”.

As previously explained, in both the radio terminal a21a and the base station A20, the communications are set by using the management frame and the register tables 14 and 34, and thereafter, the data packets are transmitted/received at the registered transmission rates (steps 65 and 66).

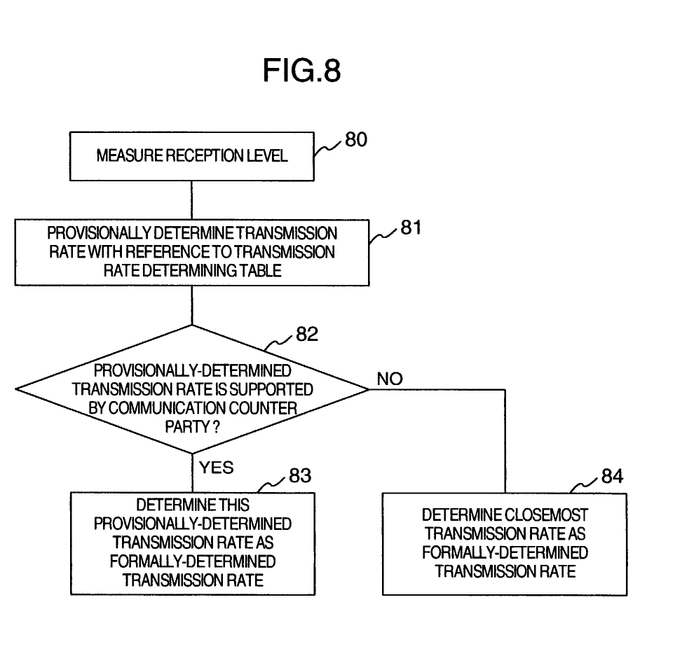

That is to say, as previously explained, the method for setting the transmission rates with respect to each of the communication counter parties will now be explained with reference to a flow chart shown in FIG. 8. It should be understood that the below-mentioned process operations may be executed by any one of the MAC processing unit 13 (or MAC processing unit 33) or the control unit 15 (or control unit 37), and the control unit 37 (or control unit 15).

As previously described, both a base station and a radio terminal transmit/receive various sorts of management frames (signals) prior to a communication.

While a management frame (signal) is received, in a reception station (either base station or radio terminal), a reception level of the received management frame is measured by the modulating/demodulating unit 12 (or modulating/demodulating unit 32), a reception level from a communication counter party is determined based upon at least one of the measured reception levels (step 80), and then, the determined reception level is notified to the MAC processing unit 13 (or MAC processing unit 33).

The MAC processing unit 13 (or MAC processing unit 33) provisionally determines one optimum transmission rate with reference to the transmission rate determining table (see FIG. 7B) based upon the determined reception level, and then, temporarily stores this optimum transmission rate into the memory employed in either the MAC processing unit 33 (or MAC processing unit 13) or the control unit 37 (or control unit 15) (step 81). Thereafter, the MAC processing unit 13 (or MAC processing unit 33) or the control unit 15(or control unit 37)determines a plurality of transmission rates at which communications can be carried out with respect to the communication counter party based upon the Supported Rate field contained in the Prob Request signal or the Prob Response signal sent from the received communication counter party. Then, the MAC processing unit 13 temporarily stores the determined plural transmission rates into the memory contained in the MAC processing unit 13 (or MAC processing unit 33) or control unit 15 (or 37). Subsequently, the MAC processing unit (or 33) or the control unit 15 (or 37) determines as to whether or not the provisionally-determined transmission rate is contained in the above-described plural transmission rates at which the communications can be carried out (step 82). In other words, the MAC processing unit 13 determines as to whether or not the provisionally-determined transmission rate can be supported by the communication counter party. In the case that the MAC processing unit 33 determines that the provisionally-determined transmission rate can be supported by the communication counter party, this provisionally-determined transmission rate is written into the register table 14 (or register table 34) of FIG. 7A as a formally-determined transmission rate.

In the case that the provisionally-determined transmission rate is not supported by the communication counter party, the closemost transmission rate with respect to the provisionally-determined transmission rate is selected from the supported transmission rates, and then, the selected closemost transmission rate is written into the register table 14 (or 34) as the formally-determined transmission rate. That is, such a closemost transmission rate on the side of lower transmission rate than this provisionally-determined transmission rate is selected to be written as the formally-determined transmission rate into the register table 14.

For example, in such a case that transmission rates supported by a reception station correspond to all of the transmission rates shown in FIG. 7B, but transmission rates supported by a communication counter party are only 6 Mbit/s, 12 Mbit/s, 24 Mbit/s, and 36 Mbit/s, and furthermore, the provisionally-determined transmission rate corresponds to 48 Mbit/s, the transmission rate of 36 Mbit/s may be formally determined as the transmission rate. It should also be noted that the respective transmission rates of 9 Mbit/s, 18 Mbit/s, 36 Mbit/s, 48 Mbit/s, and 54 Mbit/s are provided as optional transmission rates. Alternatively, in the above-described step 81, while the provisionally-determined transmission rate is once registered in the register table 14 (otherwise register table 34) in correspondence with the transmission source MAC address, this registered provisionally-determined transmission rate may be updated, or overwritten by such a transmission rate which is subsequently and formally determined. It should also be noted that in a radio terminal, while a transmission rate register table may be constructed of a volatile memory, a transmission rate registered in this transmission rate register table may be erased every time the power supply of this radio terminal is turned OFF, and also, may be reset every time the power supply is turned ON.

It should also be noted that such tables shown in FIG. 7A to FIG. 7C may be provided in the register table 14 (or register table 34).

Also, in a reception station (either base station or radio terminal), a transmission rate which has been registered in a transmission rate register table is reset every time this reception station is newly connected to a communication station.

FIG. 7A to FIG. 7C are diagrams for illustratively indicating tables which have been stored (registered) into the register table 14 (or register table 34) shown in FIG. 1. FIG. 7A shows a transmission rate register table, FIG. 7B represents a transmission rate determining table, and FIG. 7C denotes a transmission rate updating table.

For example, in accordance with the sequence shown in FIG. 5, until a radio terminal starts to communicate with a base station, both the radio terminal and the base station receive signals of management frames transmitted from the respective communication counter parties, and then, determines a transmission rate based upon measured reception levels of the received management frame signals with reference to the transmission rate determining table of FIG. 7B.

For instance, when a reception level is −72 dBm, 24 Mbit/s is provisionally determined as a transmission rate. If this provisionally-determined transmission rate of 24 Mbit/s is supported by a communication counter party, then this supported transmission rate of 24 Mbit/s is formally selected. Also, when a reception level is −60 dBm, 54 Mbit/s is provisionally determined as a transmission rate. If this provisionally-determined transmission rate of 54 Mbit/s is supported by a communication counter party, then this supported transmission rate of 54 Mbit/s is formally selected.

Then, as indicated by the transmission rate register table of FIG. 7A, the values of the selected transmission rates are registered into a predetermined MAC address (for example, 11-22-33-00-00-01) which corresponds to the communication counter party. This MAC address corresponds to, for example, Address 1 though Address 4 of the MAC header indicated in FIG. 4A.

However, according to the aforesaid transmission rate determining method, when the transmission rate register table is formed by a nonvolatile memory, once the transmission rate is determined as to the same transmission destination, even if propagation conditions of radio waves changes between the transmission destination and the transmission source, the communication is continued therebetween at the same transmission rate. The propagation conditions of radio waves changes depending on weather conditions and also changes depending on road condition or running environments of a vehicle (for example, urban, suburb, tunnel etc.) in the case of vehicle mounted radio terminals, for example.

In this manner, even when a communication is carried out at a transmission rate determined in the above-described manner, the below-mentioned cases may occur. That is, since a propagation condition of radio waves is thereafter changed, this communication can be hardly carried out at the presently-used transmission rate. Conversely, if the communication is carried out at such a transmission rate higher than the presently-used transmission rate, then the resulting transmission efficiency may be increased.

To this end, in accordance with the present invention, when the propagation conditions of radio waves changes, the transmission rate is changed in accordance with the propagation conditions of radio waves even during the communication of data.

That is, while both a total transmission number of times and a total transmission failure number of times are counted every MAC address, a communication condition is monitored, and then, when a rate of the total transmission failure number of times to the total transmission number of times equals to or exceeds a predetermined value, it is so determined that the monitored communication condition is deteriorated. As a result, such a control operation may be performed in that the presently-used transmission rate is set to a lower transmission rate than this presently-used transmission rate. Also, in the case that a rate of the total transmission failure number of times to the total transmission number of times is smaller than the predetermined value, it is so determined that the monitored communication condition is improved. As a result, such a control operation may be carried out in that the presently-used transmission rate is set to a higher transmission rate than this presently-used transmission rate.

For example, in the case that a transmission failure rate acquired for a constant past time period is higher than, or equal to 20%, the presently-used transmission rate is changed into a lower transmission rate than this presently-used transmission rate by 1 step. In the case that a transmission failure rate acquired for a constant past time period is smaller than 1%, a content of a register table is updated in such a manner that the presently-used transmission rate is changed into a higher transmission rate than this presently-used transmission rate by 1 step. It should also be noted that as to a relationship between the total transmission failure rate and the transmission rate to be updated, values may be previously set to either a base station or a radio terminal. As a result, a radio communication system capable of accepting a change in radio wave propagation conditions can be realized.

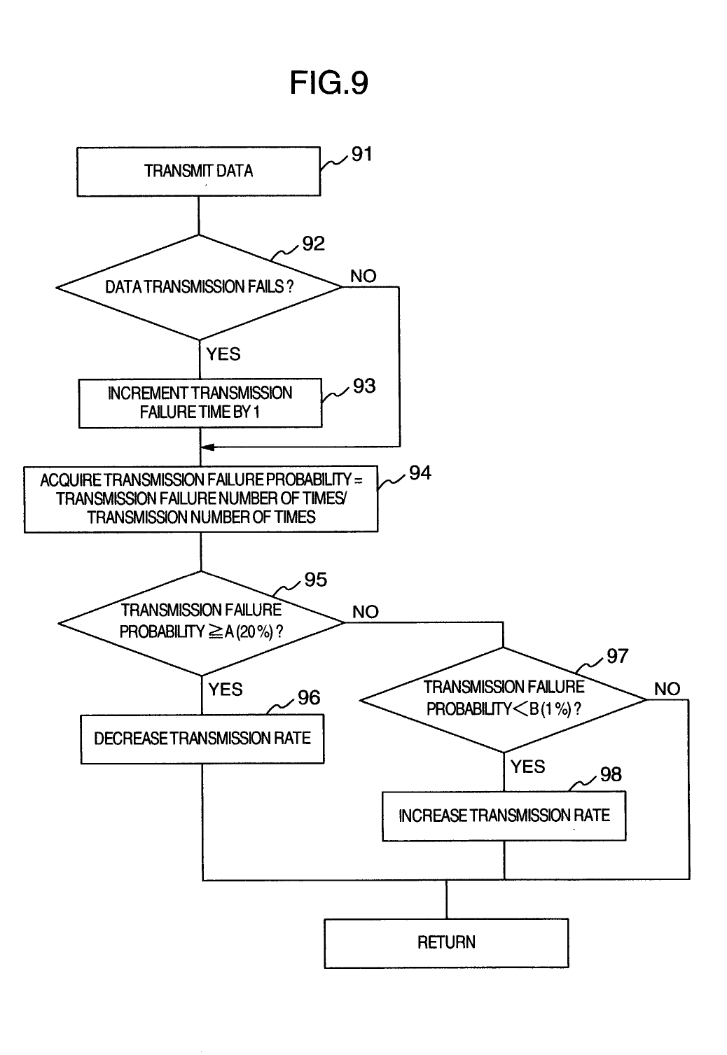

Referring now to a flow chart shown in FIG. 9, a description is made of the above-described process operation for resetting the transmission rates in response to the propagation conditions of the radio waves. This process operation may be carried out in either the MAC processing unit 13 (or MAC processing unit 33) or the control unit 37 (or control unit 15).

In a transmission source (both base station and radio terminal), a large number of data packets are transmitted during a single transmission operation. It should be understood that the below-mentioned process operation defined from a step 91 to a step 98 corresponds to a process operation executed every time one data packet is transmitted.

First, while the transmission source transmits one data packet (step 91), the transmission source waits for the ACK signal from a transmission destination and retransmits the data packet when receiving no ACK signal from the transmission destination and determines that this data packet transmission fails when the number of the retransmission exceed a predetermined number, the transmission source determines that the data packet transmission fails (step 92). When, the transmission source determines that the data packet transmission fails, a count value of a counter (software counter) employed in either the MAC processing unit 13 (otherwise MAC processing unit 33) or the control unit 37 (otherwise control unit 15) is incremented by 1 (step 93), and then, the process operation is advanced to a further step 94. To the contrary, when the transmission source determines that the data packet transmission can succeed, the process operation is advanced to the step 94 without changing the count value of this counter. It should be understood that the count value is reset every time a predetermined time period lapses or every time the transmission rate is changed.

As previously explained, in accordance with the present invention, the counting operation for the transmission number of times of the data packet is carried out in the layer lower than, or equal to the MAC layer.

Next, transmission failure probability is calculated as a ratio of an accumulated transmission number of times of data packets to an accumulated transmission failure number of times of data packets, namely as the accumulated transmissions failure number of times/the accumulated transmission number of times. In this case, the calculation of the transmission failure probability is carried out when the accumulated transmission number of times of the data packets become larger than, or equal to a predetermined number of times (for example, 10 times).

Subsequently, either the MAC processing unit 13 (or MAC processing unit 33) or the control unit 37 (or control unit 15) determines as to whether or not the transmission failure probability higher than, or equal to a predetermined value “A” (for instance, 20%) in a step 95. When the transmission failure probability is higher than or equal to this predetermined value “A”, the MAC processing unit 13 (or 33), or the control unit 37 (or 15) again sets the presently-used transmission rate to such a lower transmission rate than the presently-used transmission rate (step 96). On the other hand, in the case that the MAC processing unit 13 (or 33), or the control unit 37 (or 15) determines that the transmission failure probability is smaller than the predetermined “A”, this MAC processing unit 13 (or 33), or this control unit 37 (or 15) furthermore determines as to whether or not the transmission failure probability is smaller than a preselected value “B” (for example, 1%) in a step 97. When the transmission failure probability is smaller than this preselected value “B”, the MAC processing unit 13 (or 33), or the control unit 37 (or 15) again sets the presently-used transmission rate to such a higher transmission rate than the presently-used transmission rate (step 98). Similarly, the MAC processing unit 13 (or 33), or the control unit 37 (or 15) executes a process operation similar to the above-explained process operation with respect to the next data packet transmission.

In other words, for example, while a data packet communication is carried out, in such a case that a total transmission failure number under counting operation higher than, or equal to 20%, the MAC processing unit 13 (or 33), or the control unit 37 (or 15) decreases the presently-used transmission rate by, for example, 1 stage in accordance with the transmission rate update table shown in FIG. 7C. For instance, when the presently-used transmission rate is 54 Mbit/s, this transmission rate is decreased to 48 Mbit/s. Then, the content of the transmission rate register table of FIG. 7A is updated by this value. Also, in such a case that a total transmission failure number under counting operation is smaller than 1%, the MCA processing unit 13 (or 33), or the control unit 37 (or 15) increases the presently-used transmission rate by, for example, 1 stage in accordance with the transmission rate update table shown in FIG. 7C. For instance, when the presently-used transmission rate is 24 Mbit/s, this transmission rate is increased to 36 Mbit/s. Then, the content of the transmission rate register table of FIG. 7A is updated by this value. If a total transmission failure number under counting operation equals to or exceeds 1%, or smaller than 20%, then the presently-used transmission rate is not changed, but also the content of the transmission rate register table of FIG. 7A is not changed, or updated.

On the other hand, in a communication protocol, retransmission control operation and the like are carried out in the respective layers, if necessary, so as to realize a data transmission without any error. As previously explained, since the counting operations of the transmission number of times and also the transmission failure number of times are performed in the data link layer of the OSI7 layer, an attention can be paid to such data errors occurred only in radio sections, and the transmission rates can be controlled which are adaptively adapted to the change in the radio line conditions.

In the above-described embodiment, such a case that the communication is carried out between one base station and one radio terminal has been exemplified. Alternatively, the transmission rates may be set and the transmission rate controls may be adaptively carried out every communication counter party even in such a case that a data packet communication is performed between at least one base station and at least one radio terminal, in the case that a data packet communication is performed between one base satiation and at least one separate base station, and also, in the case that a data packet communication is carried out between one radio terminal and at least one separate radio terminal.

Also, the present invention may be applied not only to the IEEE 802.11 protocol, but also to other wireless communication protocols.

In accordance with the present invention, the following effects can be achieved.

That is, since the data packet transmission can be carried out at the different transmission rates with respect to each of the communication counter parties, the throughput of the entire system can be advantageously improved. Furthermore, since the transmission rate every communication counter party can be adaptively controlled in response to the state change of the radio line, the data packet communication can be carried out at the optimum transmission rate anytime and anywhere.

Also, since an optimum transmission rate is determined by any one of a base station and a radio terminal, both either a base station or a radio terminal, which are supported by the present invention, and either another base station or another radio terminal, which are not supported, can be commonly operated within the same system. As a result, requirements of adding/changing systems and also of forming a multi-ventor may be flexibly satisfied.

Furthermore, since the transmission rate is set and the adaptive control operation is carried out based upon the information lower than, or equal to the MAC layer, no adverse influence is given to the presently-available upper-graded protocol.

It should be further understood by those skilled in the art that the foregoing description has been made on embodiments of the invention and that various changes and modifications may be made in the invention without departing from the spirit of the invention and the scope of the appended claims.

What is claimed is:

1. In a radio data communication system comprising a transmitter which transmits data at a predetermined transmission rate and has a table determining transmission rates in correspondence with reception levels of data, and a receiver which receives data transmitted from said transmitter, a data transmission method in said radio data communication system comprising the steps of:
a) detecting at said receiver data error of the data transmitted from said transmitter;
b) transmitting detecting result of the data error at said receiver to said transmitter; and
c) calculating a transmission failure rate at said transmitter, in response to the detecting result of the data error transmitted from said receiver, and changing the transmission rate of said transmitter, with reference to said table based on the transmission failure rate.

2. A radio data communication method as claimed in claim 1, further comprising a step of:
d) at each of the transmitter and the receiver, measuring a reception level of a signal which is transmitted from a communication counter party and is received, and determining a transmission rate of data to be transmitted to the communication counter party based upon the measured reception level and transmitting to the communication counter party at the determined transmission rate.

3. A radio data communication method as claimed in claim 2 wherein:
each of said transmitter and receiver measures a reception level of a management signal, or a control signal, which are received from the communication counter party, prior to the transmission of the data.

4. A radio data communication method as claimed in claim 3 wherein:
each of said transmitter and receiver determines a plurality of transmission rates at which data can be transmitted to a communication counter party based upon the management signal received to the communication counter party, and determines one transmission rate corresponding to the measured reception level among the determined plural transmission rates at which the data can be transmitted to the communication counter party, as a transmission rate of the data transmitted to the communication counter party.

5. A radio data communication method as claimed in claim 1 wherein:
the step c) is comprised of:
a step c1) for counting both a total transmission number of times of data and either a total transmission success number of times of data or a total transmission failure number of times of data in the transmitter in response to the detecting result of the data error;
a step c2) in which when a ratio of a total transmission failure number of times with respect to a total transmission number of times in the transmitter exceeds a first predetermined value, a transmission rate of data transmitted to the receiver is changed into a lower transmission rate than the transmission rate;
a step c3) in which when a ratio of a total transmission failure number of times with respect to a total transmission number of times in the transmitter is smaller than a second predetermined value, a transmission rate of data transmitted to the receiver is changed into a higher transmission rate than the transmission rate; and
a step c4) in which, subsequently, the data is transmitted at the changed transmission rate to the receiver.

6. A radio data communication method as claimed in claim 5, further comprising the steps of:
registering thereinto the transmission rates determined by the step d) with respect to the receiver; and
when a transmission rate of data transmitted to the receiver is changed by the step c), updating the transmission rate of the data corresponding to the receiver, which has been previously registered, by the changed transmission rate, wherein, subsequently, the data is transmitted to the receiver at the updated transmission rate.

7. A radio data communication method as claimed in claim 6 wherein:
the register step registers thereinto the transmission rate determined by the step d) in correspondence with an MAC (Media Access Control) address of the receiver.

8. A radio data communication method as claimed in claim 5 wherein:
the step c) counts a total transmission number of times of data at a layer lower than, or equal to an MAC layer.

9. A radio data communication system comprising:
a transmitter which transmits data at a predetermined transmission rate and has a table determining transmission rates in correspondence with reception levels of data; and
a receiver which receives data transmitted from said transmitter, wherein
said receiver detects data error of the data transmitted from said transmitter and transmits detecting result of said data error to said transmitter, and
said transmitter calculates a transmission failure rate in response to said detecting result of the data error transmitted from said receiver, said transmitter includes a transmission rate varying unit, in which said transmission rate in changed with reference to said table based on said calculated transmission failure rate.

10. A radio data communication system as claimed in claim 9 wherein:
the transmission rate varying unit is comprised of:
a measuring unit for measuring a reception level of a signal which is transmitted from a communication counter party and is received by the radio unit; and
a transmission rate determining unit for determining a transmission rate of data which is transmitted to the communication counter party based upon the measured reception level; wherein:
the radio unit transmits the data to the communication counter party at the determined transmission rate.

11. A radio data communication system as claimed in claim 10 wherein:
the measuring unit measures a reception level of a management signal, or a control signal, which are received from the communication counter party, prior to the transmission of the data.

12. A radio data communication system as claimed in claim 11 wherein:
the transmission rate determining unit determines a plurality of transmission rates at which data can be transmitted to a communication counter party based upon the management signal received to the communication counter party, and determines one transmission rate corresponding to the measured reception level among the determined plural transmission rates at which the data can be transmitted to the communication counter party, as a transmission rate of the data transmitted to the communication counter party.

13. A radio data communication system as claimed in claim 9 wherein:
the transmission rate varying unit is comprised of:
a counting unit for counting both a total transmission number of times of data and either a total transmission success number of times of data or a total transmission failure number of times of data in the transmitter; and
the transmission rate varying unit is operated in such a manner that when a ratio of a total transmission failure number of times with respect to a total transmission number of times counted in the transmitter exceeds a first predetermined value, a transmission rate of data transmitted to the receiver is changed into a lower transmission rate than the transmission rate; and
the transmission rate varying unit is operated in such a manner that when a ratio of a total transmission failure number of times with respect to a total transmission number of times counted in the transmitter is smaller than a second predetermined value, a transmission rate of data transmitted to the receiver is changed into a higher transmission rate than the transmission rate; and
subsequently, the radio unit transmits the data at the changed transmission rate to the receiver.

14. A radio data communication system as claimed in claim 13 wherein:
the transmitter is further comprised of:
a register unit for registering thereinto the transmission rates determined by the transmission rate determining unit with respect to the receiver corresponding thereto; and
the register unit is operated in such a manner that when a transmission rate of data transmitted to the receiver is changed by the transmission rate varying unit, the transmission rate of the data corresponding to the receiver, which has been previously registered, is updated by the changed transmission rate, and subsequently, the transmitter transmits the data to the receiver at the updated transmission rate.

15. A radio data communication system as claimed in claim 14 wherein:
the register unit registers thereinto the transmission rate determined by the transmission rate determining unit in correspondence with an MAC (Media Access Control) address of the receiver.

16. A radio data communication system as claimed in claim 13 wherein:
the counting unit counts a total transmission number of times of data at a layer lower than, or equal to an MAC layer.
